(19) United States
(12) Patent Application Publication
(10) Pub. No.: US 2008/0114580 A1
(43) Pub. Date: May 15, 2008

(54) MIMO CHANNEL SIMULATOR

(75) Inventors: Kean Khoong CHIN, Ipoh (MY); Jiann Der SHAW, Tao Yuen (TW); Yin Khai NG, Penang (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/558,422

(22) Filed: Nov. 9, 2006

(51) Int. Cl. G06G 7/62; G06F 17/00

(52) U.S. Cl. 703/13

(57) ABSTRACT

A MIMO channel simulator for simulating the effects that a transmission channel has on at least two signals transmitted by at least two transmitting antennas that are received by at least two receiving antennas is disclosed. The simulator includes at least two input ports for connecting to the transmitting antennas to receive the two signals therefrom as two input signals to the channel simulator, and at least two output ports for connecting to the receiving antennas to send two output signals thereto. The simulator further includes at least two combiner/divider stages, in cascade in signal paths between the input and output ports. The combiner/divider stages generate the two output signals from the two input signals. Each output signal is a combination of the input signals and has a phase that is different than that of the other at least one output signal.

### BACKGROUND

The invention relates to a simulator of a radio channel, more particularly, to a simulator of a Multiple Input Multiple Output (MIMO) radio channel through which radio signals from or to several antennas propagate.

In a conventional radio, there is only one data stream being transmitted over a radio channel even if multiple antennas are used. To increase the data capacity in the radio channel, MIMO technology has been introduced. MIMO allows the simultaneous transmission of multiple data streams using respective antennas; it increases the radio channel data capacity without using additional frequency spectrum. The throughput in MIMO systems increases by a factor that is equal to the number of data streams transmitted in the radio channel. MIMO has been adopted as the foundation for defining the new IEEE 802.11n standard for next generation Wi-Fi. Testing of a MIMO device at the end of its manufacturing for compliance to the standard is thus necessary. This compliance includes meeting a minimum MIMO throughput.

The test may be carried out either under real conditions or by using a simulator simulating the real conditions. Tests conducted under real conditions are difficult since they are required to be conducted outdoors where the weather and the seasons change all the time. Measurements conducted even at the same location give different results at different times. Furthermore, a test conducted in one environment in a city does not completely apply to a similar environment in another city. The worst possible situation cannot often be tested under real conditions, either.

A device simulating a radio channel, on the other hand, can be used for quite freely simulating a radio channel having desired features between two radio devices operating at their natural transmission rates, as in a real operating situation. Typically between a transmitter and a receiver, several propagation paths exist via which a signal propagates and, furthermore, if several transmitting and/or receiving antennas are used, the situation becomes substantially more complicated to simulate. The phase and amplitude of the signal vary on each propagation path. Phase variation in particular causes fades of different duration and strength in the signal. Noise and interference caused by other transmitters also interfere with transmission on a radio channel. Assume, for instance, an arrangement which includes M transmitting antennas, a radio channel and N receiving antennas. In such a case, the channel is a Multiple Input Multiple Output (MIMO) radio channel, which is described by an N×M transfer matrix. Each element in the matrix is a time-varying impulse response for a sequence comprising the m^{th} transmitting antenna, the n^{th} receiving antenna and the radio channel therebetween.

In prior art solutions, in order to simulate the abovementioned radio channel, each matrix element is simulated by a time-varying, transversal filter, typically by a finite impulse response (FIR) filter. Although such a simulation works, it nevertheless suffers a drawback. The total number of FIR filters needed to simulate the radio channel is M×N. An arrangement is further needed to describe the correlation between the different elements of the matrix. If it is assumed that the number of different propagation paths of the signals is K, the complexity of the implementation of the prior art calculation method, expressed as the necessary multiplications, delay elements and additions, is M×N×K delays, M×N×K multiplications and M×N×K additions. It is to be noted that the complexity of a K input adder is K. The effect of the calculation of the correlation between the elements of the transfer matrix has not been taken into account herein. When the number of transmitting and receiving antennas increases, the complexity required by the calculation increases dramatically. A simulator employing such calculations would thus be complicated and costly.

A low cost MIMO Dual-Band Channel Simulator is available from Litepoint Corporation, Sunnyvale, U.S.A. The simulator has two output ports that are typically connected to two antennas of a receiver device-under-test (DUT). Two additional ports are also available for monitoring the signals at these two output ports. The MIMO Dual-Band Channel Simulator passively combines two RF input signals from a MIMO reference transmitter, creating combined output signals for the DUT. The signal at one output port is the sum of the two RF input signals. The signal at the other output is the sum of one RF input signal phase shifted by 180° and the other RF input signal phase. The phase shift and attenuation of this Litepoint simulator is fixed. The Litepoint simulator is also good for simulating only a channel with two data streams, i.e. two inputs and two outputs.

### SUMMARY

The invention may be implemented as a MIMO channel simulator for simulating the effects that a transmission channel has on at least two signals transmitted by at least two transmitting antennas that are received by at least two receiving antennas. The MIMO channel simulator includes at least two input ports for connecting to the transmitting antennas to receive the two signals therefrom as two input signals to the channel simulator. The MIMO channel simulator also includes at least two output ports for connecting to the receiving antennas to send two output signals thereto. The output ports are connected to the input ports via at least two signal paths therebetween through which the two input signals propagate. The MIMO channel simulator further includes at least two combiner/divider stages, in cascade in the signal paths, for generating the two output signals from the two input signals. Each output signal is a combination of the input signals and has a phase that is different than that of the other at least one output signal. In order to have such output signals, each of the combiner/divider stages has at least one unit that includes a combiner, a divider and a phase shifter. The combiner combines at least two input signals to the unit to produce a combined signal. The divider then divides the combined signal into at least two unit output signals. The phase shifter shifts the phase of one of the unit output signals.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is a schematic drawing of a MIMO channel simulator according to a one embodiment of the invention, the MIMO channel having two combiner/divider stages, wherein each combiner/divider stage has a unit that includes a combiner, a divider and a phase shifter;

FIG. 2 is a schematic drawing of a MIMO channel simulator similar to that in FIG. 1, wherein one of the combiner/divider stages has an additional unit and the units are hybrid dividers wherein the combiner, the divider and the phase shifter are integral; and

FIG. 3 is schematic drawing of an enhanced MIMO channel simulator according to another embodiment of the invention, having two combiner/divider stages similar to those in FIGS. 1 and 2, wherein each combiner/divider stage includes 2 hybrid divider type units similar to that used in the MIMO channel simulator in FIG. 2.

### DETAILED DESCRIPTION OF THE EMBODIMENTS

As shown in the drawings for purposes of illustration, the invention is embodied in a novel MIMO channel simulator. Existing MIMO channel simulators are either complex and costly, or are inadequate for simulating a channel supporting more than a two input two output channel; i.e. only two data streams. A MIMO channel simulator embodying the invention provides a cost effective simulation of a more complex MIMO channel. The MIMO channel simulator is able to simulate a channel with at least three inputs and two outputs, or to simulate a two input two output channel with complex phase shifts.

FIG. 1 shows a MIMO channel simulator 2 according to one embodiment of the invention. The MIMO channel simulator 2 simulates the effects a transmission channel (cannot be shown) has on two signals transmitted by two transmitting antennas (not shown) that are received by two receiving antennas (not shown). The MIMO channel simulator 2 includes two input ports 4 for connecting to the transmitting antennas to receive the two signals therefrom as two input signals to the channel simulator 2. The MIMO channel simulator 2 also includes two output ports 6 for connecting to the receiving antennas to send two output signals thereto. The output ports 6 are connected to the input ports 4 via at least two signal paths 8 therebetween through which the two input signals propagate. The MIMO channel simulator 2 further includes two combiner/divider stages 10, 12, in cascade in the signal paths 8, for generating the two output signals from the two input signals. Each output signal is a combination of the input signals and has a phase that is different than that of the other output signal. In order to have such output signals, each combiner/divider stage 10, 12 has at least one unit 14, 16 therein. Each unit 14, 16 includes a combiner 18, a divider 20 and a phase shifter 22. The combiner 18 combines at least two input signals to the unit 14, 16 to produce a first combined signal. The divider 20 then divides the first combined signal into at least two unit output signals. The phase shifter 22 shifts the phase of one of the unit output signals. It is possible that the input ports 4 and output ports 6 are two sets of input-output (I/O) ports so that the channel simulator 2 is bi-directional. In other words, input signals received at one set of I/O ports result in output signals at the second set of I/O ports. And signals received at the second set of I/O ports result in output signals at the first set of I/O ports. There may be more than two input ports 4 and two output ports 4. The number of input ports 4 and the output ports 6 may or may not be the same. The combiner 18 and the divider 20 may also be 3-way, 4-way, etc. instead of the 2-way ones shown in FIG. 1. The combiner 18, the divider 20 and the phase shifter 22 may be separate components. Alternatively, these components 18, 20, 22 may be integral. That is, these components 18, 20, 22 may be of a unitary design, such as that available in a hybrid divider. A MIMO channel simulator using such hybrid dividers will be described next.

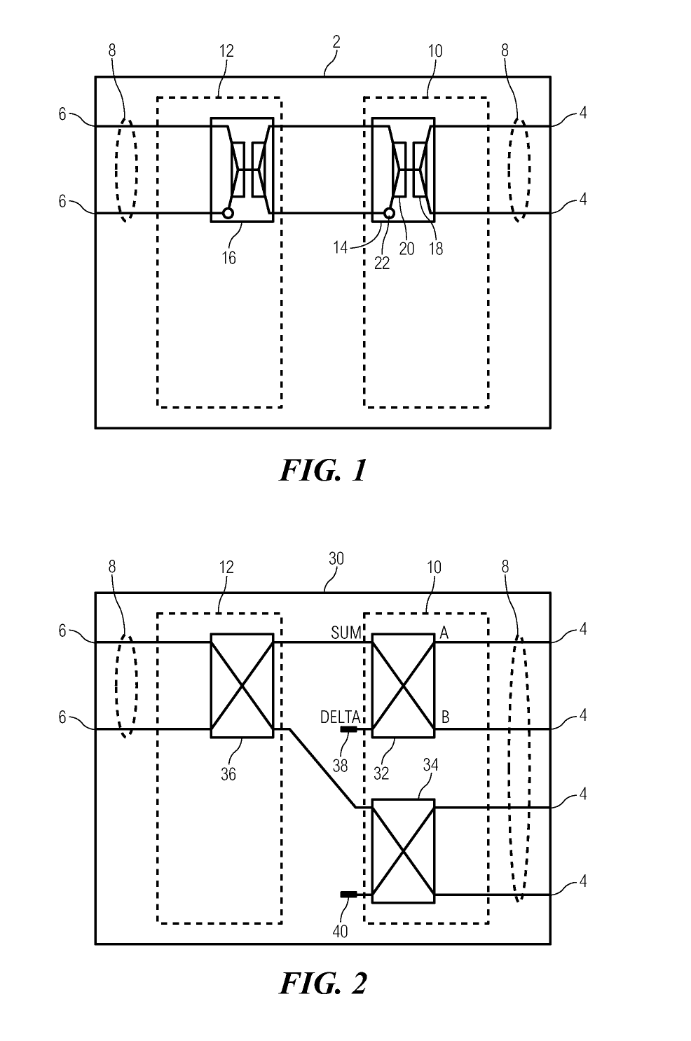

FIG. 2 shows another MIMO channel simulator 30 that is similar to the one in FIG. 1. This MIMO channel simulator 30 can simulate a channel with up to four inputs and two outputs. This MIMO channel simulator 30 includes hybrid divider type of units in the combiner/divider stages 10, 12. The first combiner/divider stage 10 includes a first and a second hybrid divider 32, 34; while the second combiner/divider stage 12 includes a third hybrid divider 36. In this embodiment, the hybrid dividers 32, 34, 36 are quadrature hybrid dividers. The quadrature hybrid dividers 32, 34, 36 are commercially available from Pulsar Microwave Corporation, New Jersey, U.S.A. Each such quadrature hybrid divider 32, 34, 36 has an A port, a B port, a SUM port and a DELTA port. Signals received at the A port and B port are combined by the quadrature hybrid divider 32, 34, 36 to produce a combined signal at the SUM port. The signals at the A port and B port are also combined and phase shifted to produce a combined signal that is phase shifted by 90° at the DELTA port. These combined signals at the SUM port and the DELTA ports of the hybrid dividers 32, 34, 36 are similar to the unit output signals of the units 14, 16 in FIG. 1. The hybrid dividers 10, 12, 14 are bidirectional. That is, signals received at the SUM and DELTA ports are similarly combined and phase shifted to produce output signals at the A and B ports.

Two first I/O ports 4 are connected to the A port and B port of the first quadrature hybrid divider 32 respectively. The other two first I/O ports 4 are connected to the A port and B port of the second quadrature hybrid divider 34 respectively. The SUM port of the first quadrature hybrid divider 32 is connected to the A port of the third quadrature hybrid divider 36. The DELTA port of the first quadrature hybrid divider 32 is terminated with a 50-ohm terminator 38. The SUM port of the second quadrature hybrid divider 34 is cross connected to the B port of the third quadrature hybrid divider 36. The DELTA port of the second quadrature hybrid divider 34 is terminated with a 50-ohm terminator 40. The SUM port and the DELTA port of the third quadrature hybrid divider 36 are connected to respective second I/O ports 6. With this arrangement, when input signals are injected into the first I/O ports 4, the output signal generated therefrom appearing at each second I/O port 6 would be a sum of all the input signals. Some signal paths 8 carry only one input signal while others, including those between the combiner/divider stages 10 and 12, carry more than one input signals. Each of the signal paths 8 to which the second I/O ports 6 are directly connected carry all the input signals.

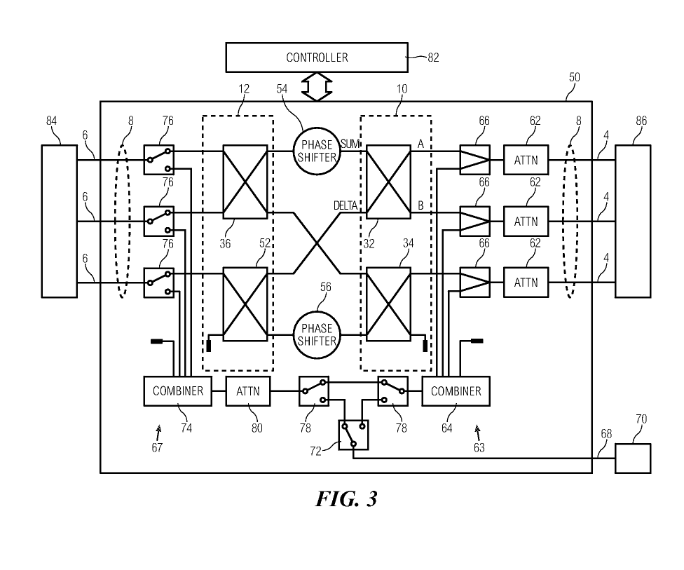

FIG. 3 shows an enhanced MIMO channel simulator 50 using four quadrature hybrid dividers 32, 34, 36, 52, according to another embodiment of the invention. This enhanced MIMO channel simulator 50 includes three first input-output (I/O) ports 4 and three second I/O ports 6, although it can be used to simulate a channel of up to four inputs and four outputs. The second I/O ports 6 are connected to the first I/O ports 4 via signal paths 8 therebetween. The four hybrid dividers 32, 34, 36, 52, are connected in two combiner/divider stages 10, 12 in cascade in the signal paths 8. When only three first I/O ports 4 are required, the B port of the second quadrature hybrid divider 34 is terminated with a 50-ohm terminator, either internally or via a first I/O port 4. Similarly, since only three second I/O ports 6 are required, the DELTA port of the fourth quadrature hybrid divider 52 is terminated with a 50-ohm terminator. A first and second phase shifter 54, 56 with adjustable phase shifts are connected between the two combiner/stages 10 and 12. The phase shift may be adjustable to a value in the range of 0° to 140°, although other ranges are also possible. The first phase shifter 54 is connected in the signal path connecting the SUM port of the first quadrature hybrid divider 32 to the A port of the third quadrature hybrid divider 36. The second phase shifter 56 is connected in the signal path connecting the DELTA port of the second quadrature hybrid divider 34 to the B port of the fourth quadrature hybrid divider 52. The phase shifters 54, 56 may also be of a fixed phase shift of, for example, 45°. The enhanced MIMO channel simulator 50 also includes three attenuators 62, each of which is connected between a first I/O port 4 and the respective A or B port of the quadrature hybrid dividers 32, 34 of the first combiner/divider stage 10 for attenuating the signal therebetween. These attenuators 62 may be of a fixed or programmable attenuation. For programmable attenuators 62, the attenuation value may be programmed to a value in a range, for example, 0-121 dB.

To allow monitoring of the signals at the first I/O ports 4, the enhanced MIMO channel simulator 50 further includes a circuit 63 for combining the input signals to produce a second combined signal at a measurement port 68. A spectrum analyzer 70 may be connected to this measurement port 68. This circuit 63 includes a first signal combiner 64 and three power dividers 66. The first signal combiner 64 has four inputs and a single output. Each power divider 66 is connected in the signal path between an attenuator 62 and the first combiner/divider stage 10. Each power divider 66 connects the associated attenuator 62 simultaneously to the first combiner/divider stage 10 and to one of the inputs of the first signal combiner 64 to tap the input signal propagating through the signal path between the attenuator 62 and the first combiner/divider stage 15. The measurement port 68 is connected to the output of the first signal combiner 64. Similarly, to allow monitoring of the signals at the second I/O ports 6, the MIMO channel simulator 50 further includes a circuit 67 for connecting a selected second I/O port 6 to the measurement port 68, and a first switch 72 for selecting between connecting the measurement port 68 to the output of the first signal combiner 64 and to a selected second I/O port 6. This circuit 67 includes a second signal combiner 74 and three second switches 76. The second signal combiner 74 has multiple inputs and a single output. Each second switch 76 is connected in the signal path between a second I/O port 6 and the second combiner/divider stage 12. The second switch 76 is individually switchable to connect the associated second I/O port 6 to either the second combiner/divider stage 12 or to an input of the second signal combiner 74. The MIMO channel simulator 50 further includes a pair of third switches 78 connected between the first signal combiner 64, the second signal combiner 74 and the first switch 72, for connecting the outputs of the two combiners 64, 74 to each other or to the first switch 72. The MIMO channel simulator 50 also includes an attenuator 80 connected between the output of the second signal combiner 74 and the third switch 78 connected thereto. The MIMO channel simulator 50 also includes a controller 82 that is connectable to a computer (not shown) for remote controlling the switches 72, 76, 78 and programmable components.

Some tests that may be carried out on a device-under-test (DUT) 84 using the MIMO channel simulator 50 are next described. A reference unit 86 is connected to the first I/O ports 4 and the DUT 84 is connected to the second I/O ports 6. The DUT 84 may be for example a Wi-fi network adapter or a Wi-fi network access point. The spectrum analyzer 70 is connected to the output port 68 of the simulator 50. To obtain the receiver parameters of the DUT 84, the second switches 76 are switched to the Up position in FIG. 3 to connect the second I/O ports 6 to the second combiner/divider stage 12. This connection allows the DUT 84 to be connected to the SUM and DELTA ports of the third and the fourth hybrid dividers 36, 52. The appropriate test signals are transmitted by the reference unit 86 through the MIMO channel simulator 50 to the DUT 84. The MIMO channel simulator 50 simulates the propagation of these test signals through a radio channel, wherein the test signals are attenuated, combined and phase shifted. The signals received at the DUT 84 allow parameters such as the MIMO throughput of the DUT 84 to be determined by a computer (not shown) connected thereto. The computer may run for example the NetIQ Corp.'s Charot end-to-end performance measurement software for determining the MIMO throughput of the DUT 84.

The third switch 78 connected to the first signal combiner 64 is switched to the Down position and the first switch 72 is switched to the Right position to allow any one of the first I/O ports 4 to be monitored using the spectrum analyzer 70. Such an arrangement is necessary for measuring the output power of the reference unit 62 so that the attenuation value of the attenuators 62 may be adjusted to obtain a signal of a known strength for use in testing the sensitivity of the DUT 84.

When the first switch 72 is switched to the Left position and the third switch 78 connected to the second signal combiner 74 is switched to the Down position, the spectrum analyzer 70 is connected to one or more second I/O ports 6 when their associated second switch 76 is switched to the Down position. When only one of the second switches 76 is switched to the Down position, the respective port of the DUT 64 connected thereto can be individually monitored to check its signal transmission for carrying out tests such as a power test and a frequency error test or for calibrating the DUT 84.

When the pair of third switches 78 are switched to the Up position as shown in FIG. 3, the hybrid dividers 32, 34, 36, 52 in the signal paths between the first I/O ports 4 and the second I/O ports 6 are bypassed. Such an arrangement will allow testing of each port of the DUT 84 in a Multiple Input Single Output (MISO) or Single Input Single Output (SISO) environment.

Advantageously, the MIMO channel simulators described above support simulation of a channel with three or more inputs and two or more outputs, or a channel with two inputs and two outputs with complex phase shifts. The enhanced MIMO channel simulator 50 allows path fading and losses, and phase changes to be adjusted to more realistically simulate a channel. This enhanced MIMO channel simulator 50 is also easily configurable for simulating a SISO, Single Input Multiple Output (SIMO) and MISO channel that is required in wireless local area network (WLAN) testing.

Although the present invention is described as implemented in the above described embodiments, it is not to be construed to be limited as such. For example, 180° hybrid dividers may be used in the place of the quadrature hybrid dividers.

As another example, the phase shifter may also be connected to any signal path and not just to that between the combiner/divider stages as described above. Similarly, the attenuator may be connected to any signal path other than those carrying only one single input signals as described in the embodiments above. In other words, the attenuator may be used to attenuate a signal that is a combination of two or more signals.

What is claimed is:

1. A Multiple Input Multiple Output (MIMO) channel simulator for simulating the effects that a transmission channel has on at least two signals transmitted by at least two transmitting antennas that are received by at least two receiving antennas, the MIMO channel simulator comprising:
at least two input ports for connecting to the transmitting antennas to receive the two signals therefrom as two input signals to the channel simulator;
at least two output ports for connecting to the receiving antennas to send two output signals thereto, the output ports being connected to the input ports via at least two signal paths therebetween through which the two input signals propagate; and
at least two combiner/divider stages, in cascade in the signal paths, for generating the two output signals from the two input signals, wherein each of the output signals is a combination of the input signals and has a phase that is different than that of the other at least one output signal, and wherein each of the combiner/divider stages has at least one unit including:
a combiner for combining at least two input signals to the unit to produce a first combined signal;
a divider for dividing the first combined signal into at least two unit output signals; and
a phase shifter for shifting the phase of one of the unit output signals.

2. A MIMO channel simulator according to claim 1, wherein the unit is a hybrid divider wherein the combiner, the divider and the phase shifter are integral.

3. A MIMO channel simulator according to claim 2, wherein the hybrid divider comprises a quadrature hybrid divider.

4. A MIMO channel simulator according to claim 1, wherein the combiner/divider stages are cross connected such that each output signal at an output port is a combination of all input signal at the input ports.

5. A MIMO channel simulator according to claim 4, wherein the MIMO channel simulator further comprises at least one phase shifter in at least one signal path.

6. A MIMO channel simulator according to claim 5, wherein the phase shifter comprises a phase shifter with a programmable phase shift.

7. A MIMO channel simulator according to claim 5, wherein the phase shifter is in one of the signal paths between two combiner/divider stages.

8. A MIMO channel simulator according to claim 7, wherein the at least one phase shifter comprises a phase shifter connected to an output of each unit.

9. A MIMO channel simulator according to claim 4, wherein the MIMO channel simulator further comprises:
at least one attenuator connected in one of the signal paths for attenuating at least one input signal of the channel simulator.

10. A MIMO channel simulator according to claim 9, wherein the attenuator comprises an attenuator with a programmable attenuation.

11. A MIMO channel simulator according to claim 9, wherein the attenuator is connected in a signal path carrying only one input signal of the channel simulator.

12. A MIMO channel simulator according to claim 4, wherein MIMO channel simulator further comprises:
a circuit for combining the input signals of the channel simulator to produce a second combined signal; and
a measurement port through which the second combined signal is accessible.

13. A MIMO channel simulator according to claim 12, wherein the circuit for combining the input signals comprises:
a plurality of power dividers, each connected to a signal path for tapping an input signal of the channel simulator; and
a first power combiner for combining the tapped input signals to produce the second combined signal.

14. A MIMO channel simulator according to claim 13, wherein the MIMO channel simulator further comprises:
a circuit for connecting a selected output port to the measurement port; and
a first switch for selecting between connecting the measurement port to the first power combiner and to a selected output port.

15. A MIMO channel simulator according to claim 14, wherein the circuit for connecting a selected output port to the measurement port comprises:
a second power combiner connected to the first switch; and
a plurality of second switches, each connected to an output port for switching the output port between being connected to a signal path and to the second power combiner.

16. A MIMO channel simulator according to claim 15, wherein the MIMO channel simulator further comprises:
a pair of third switches connected between the first signal combiner, the second signal combiner and the first switch, for connecting the two combiners to each other or to the first switch.

17. A MIMO channel simulator according to claim 16, wherein the MIMO channel simulator further comprises:
an attenuator connected between the second signal combiner and one of the third switches.
